(19) United States
(12) Patent Application Publication
(10) Pub. No.: US 2019/0190952 A1
(43) Pub. Date: Jun. 20, 2019

(54) SYSTEMS AND METHODS FOR DETECTING A CYBERATTACK ON A DEVICE ON A COMPUTER NETWORK

(71) Applicant: Mercy Health, Cincinnati, OH (US)

(72) Inventor: Ronald Cherry, Cincinnati, OH (US)

(73) Assignee: Mercy Health, Cincinnati, OH (US)

(21) Appl. No.: 16/210,941

(22) Filed: Dec. 5, 2018

Related U.S. Application Data
(60) Provisional application No. 62/607,951, filed on Dec. 20, 2017.
(60) Provisional application No. 62/703,495, filed on Jul. 26, 2018.

(51) Int. Cl. H04L 29/06

(52) U.S. Cl. CPC H04L 63/1491; H04L 63/1416

(57) ABSTRACT

Systems and methods are described herein for detecting a cyber-attack on a device on an organization's computer network.

### CROSS REFERENCE TO RELATED APPLICATION

This patent application claims the benefit of U.S. Provisional Patent Application No. 62/607,951, filed Dec. 20, 2017, and U.S. Provisional Patent Application No. 62/703,495, filed Jul. 26, 2018, the entire contents of which are incorporated herein by reference.

### TECHNICAL FIELD

This disclosure generally relates to systems and methods for detecting a cyberattack on a device on a computer network.

### BACKGROUND

Firewalls are commonly relied on by organizations, such as medical facilities (e.g., hospitals, out-patient locations, etc.), to safeguard their internal systems, computers, devices, or the like, against unwanted cyber-attacks. Firewalls can have vulnerabilities and can leave the organizations computer network open to unwanted activity. For example, a change in firewall settings will change a vulnerability status of the computer network. Moreover, the vulnerability status of the computer network can also change anytime a new service is initiated on a host on the network, or the configuration of any network service running on the host is changed. Intruders can exploit services on the organization's network, or vulnerabilities in the organization's firewall with malware. To combat cyber-attacks, such as malware, firewalls can be configured with an antivirus program. In some instances, the antivirus program can be configured to operate along-side with the firewall. The antivirus program is configured to prevent the malware from taking root and eliminate discovered malware on the organization's network. Correspondingly, the antivirus program can detect and mitigate threats internally or externally to the organization's network. To provide an additional layer of security for their networks, some organizations employ more sophisticated security measures, such as intrusion detection systems. Intrusion detection systems can monitor the organization's network and systems for malicious activity and/or policy violations according to classification techniques. Intrusion detection classification techniques can include misuse intrusion detection and anomaly intrusion detection. The first type of classification technique search for occurrences of known attacks with a particular “signature,” and the second type of classification technique searches for a departure from normality (e.g., for an anomaly).

### SUMMARY

In an example, a computer-implemented method can include configuring a given medical device of a plurality of medical devices on a subnet of a medical facility computer network as a decoy medical device, and receiving event log data associated with the decoy medical device. The event log data can include information that can characterize one or more events at the decoy medical device, and at least one event of the one or more events can be associated with a cyberattack on the decoy medical device. The computer implemented method can further include generating indicator of compromise (IOC) data based on the event log data and generating an alert based on the IOC data. The alert can be indicative of the cyberattack on at least one other medical device on the given subnet as the decoy medical device.

The summary is provided merely for purposes of summarizing some example embodiments so as to provide a basic understanding of some aspects of the disclosure. Accordingly, it will be appreciated that the above described examples should not be construed to narrow the scope or spirit of the disclosure in any way. Other examples, embodiments, aspects, and advantages will become apparent from the following detailed description taken in conjunction with the accompanying drawings.

### BRIEF DESCRIPTION OF THE DRAWINGS

FIG. 1 illustrates an exemplary network architecture in which systems and methods described herein can be implemented.

FIG. 2 depicts an example of a flow diagram illustrating an exemplary method for detecting a cyberattack on a medical device on a hospital computer network.

FIG. 3 schematically illustrates an exemplary computing environment in which systems and methods described herein can be implemented.

### DETAILED DESCRIPTION

Medical facilities (e.g., hospitals), including other organizations, rely on a combination of antivirus programs, firewalls, intrusion detection systems, and internal security control measures such as segmentation, within network based virtual local area networks (VLANs), and vulnerability scanning to protect (or secure) their medical devices from unwanted activity. However, vulnerabilities in existing firewalls, outdated virus definitions, and intrusion classification techniques has resulted medical devices having weakened cyber-security protection and exposed to unwanted cyber-attacks. Moreover, conventional techniques visa-via segmentation and vulnerability scanning lack detection capabilities to determine if an advanced persistent threat malicious software has infected a device and/or hardware. In some instances, vulnerability scanning of medical devices on medical facilities computer networks can result in a medical device going offline while the device is in use (e.g., being used by a patient, or monitoring the patient). In addition, medical devices that were developed by medical manufactures typically have a private network that can be integrated into the hospitals computer network, e.g., via a virtual private network connection. This type of network configuration can allow a vendor (e.g. a medical device providers) access to support of medical device as a pivot point into the corporate network (e.g., backdoor) that bypasses internal security controls such as firewalls, intrusion prevention, and security operations center monitoring. As such, existing medical facilities cybersecurity measures do not adequately protect medical devices on their computer networks. Medically infected devices leave the devices and the hospital's computer network vulnerable. This can lead to devastating and in some instances catastrophic events, such as loss of human life.

Medical device providers have equipped medical devices with security capabilities (e.g., with a local firewall, antivirus, and/or intrusion detection and prevention system) in an attempt to combat unwanted intrusions and actors. However, rigid Food and Drug Administration (FDA) guidelines prevent tampering with and/or modifying the hardware and software (of medical devices (e.g., by installing a simple network management protocol (SNMP) agent) without a formal submission to the FDA for consideration and approval. As a result, medical device manufacturers have neglected or chose not to address the security concerns associated with these devices. For example, features that are often missing from medical devices can include, but not limited to, operating system hardening, secure boot, patch updates, client security services such as personal firewall (e.g., an embedded local firewall at the medical device), antimalware, host intrusion prevention (e.g., intrusion detection capability), security event reporting, support for command audit log, encrypted data storage, management system integration and/or remote policy management, authentication services such as an 802.1X supplicant, and the like.

It can be time-consuming and a financially cost-prohibitive process to validate compliance after a medical device modification. Thus, medical devices employed in hospital settings are often operated by humans while being defenseless against cyberattacks, and manufactures have little incentive to provide security updates as new medical device vulnerabilities are discovered. Moreover, many medical devices in hospitals have been in operations for years without any modifications that improve or address their security posture. A compromise or failure in any of these devices can result in a failure of the treatment or even death. In addition, many existing medical devices being employed currently in hospitals are based on designs that predated cyber-security threats.

Even further, medical devices are ideal entry points for unauthorized users (e.g., hackers) into a medical facilities computer network as a result of their security weaknesses. A weakly secured medical device can be used by an unauthorized user to introduce malware onto the medical facilities computer network. The malware can make its way via the medical facilities computer network onto other systems connected to the network. These systems can include, but not limited to, electronic medical records (EMRs), picture archiving and communication systems (PACS), remote access data and storage systems, remote service systems, and informational systems, and the like. A security breach in any of these systems can lead to losses in patient data, which can result in reputational and financial harm to the medical facility.

To combat the security risks associated with medical devices, the FDA has mandated that each manufacture establish and maintain procedures (e.g., providing security patches, antimalware, and encryption) for implementing corrective and preventive actions. However, this FDA mandate is at odds with the FDA directive that prohibits medical device changes without formal submission and approval by the FDA. Although, the FDA has placed a duty on medical device manufacturers to secure their devices from cyber threats, many of these manufactures are not vigilant in seeking out security flaws in their own devices. Thus, medical devices currently being used at a medical facility can pose a great security threat to the medical facility and its patients. Furthermore, once these devices are deployed at the medical facility, medical facility administrators are fearful in allowing medical device manufacturers to make modifications and/or updates to the devices since such changes could compromise the intended functionality of these devices, which could lead to a catastrophic event (e.g., death).

The present disclosure relates to systems and methods for detecting a cyber-attack on an organization's computer network, including a medical facility computer network. The systems and methods described herein can be used to mitigate cyber security vulnerabilities in devices employed on the organization's computer network. The term “unsecured” as used herein can refer to any device on the organizations' computer network that can leave the organization's computer network open to a cybersecurity threat (e.g., a malware attack). The systems and methods described herein can be used to detect cybersecurity threats originating within the organization's computer network or externally, such as on the Internet. The term “organization” as used herein can refer to any grouping of individuals or units of individuals including communities, companies, corporations, entities, private organizations, non-private organizations, individuals, or the like. The examples of the systems and methods described herein are in context of mitigating cybersecurity threats posed by medical devices on a medical facility computer network. However, the examples herein should not be construed and/or limited to only mitigating cybersecurity threats posed by medical devices. The systems and methods described herein can be equally applied to mitigating cybersecurity threats associated with devices operating on any computer network.

According to the systems and methods described herein, cybersecurity risks caused by unsecured medical devices in medical settings can be identified and subsequently mitigated. The systems and methods described herein can mitigate the technical liabilities that vulnerable medical devices pose to themselves, as well as the computer network to which these devices are coupled. Consequently, the systems and methods described herein can be used to prevent (or reduce) the spread of malware to other devices and/or systems on the medical facilities computer network. By employing the systems and methods described herein, medical facility administrators can detect beforehand a complete medical device compromise and/or failure. Thus, the systems and methods described herein can reduce a likelihood of a failure in treatment and/or loss in human life. Moreover, the systems and methods described herein permit medical facilities to employ medical devices designed on predated cyber-security threats, and thus alleviating the medical facilities concerns that outdated devices pose to their network.

Additionally, the systems and methods described herein can detect cyberattacks on medical devices regardless of whether existing medical facility firewalls (e.g., hardware or software based), antivirus programs and intrusion detection and prevention systems are capable of detecting such intrusions. Furthermore, the systems and methods described herein comply with the FDA guidelines. Therefore, employing the systems and methods described herein does not require tampering with or modifying the hardware and software of medical devices, and/or relying on medical device manufacturers to address the security risks associated with their devices. By employing the systems and methods described herein, medical facilities can adequately secure their computer network infrastructure from cyber-attacks originating from unsecured medical devices on their computer networks. According to the systems and methods described herein, a cyberattack on a medical device or a decoy medical device on a similar medical facility subnet can be identified based on event log data associated with the decoy medical device on the given subnet.

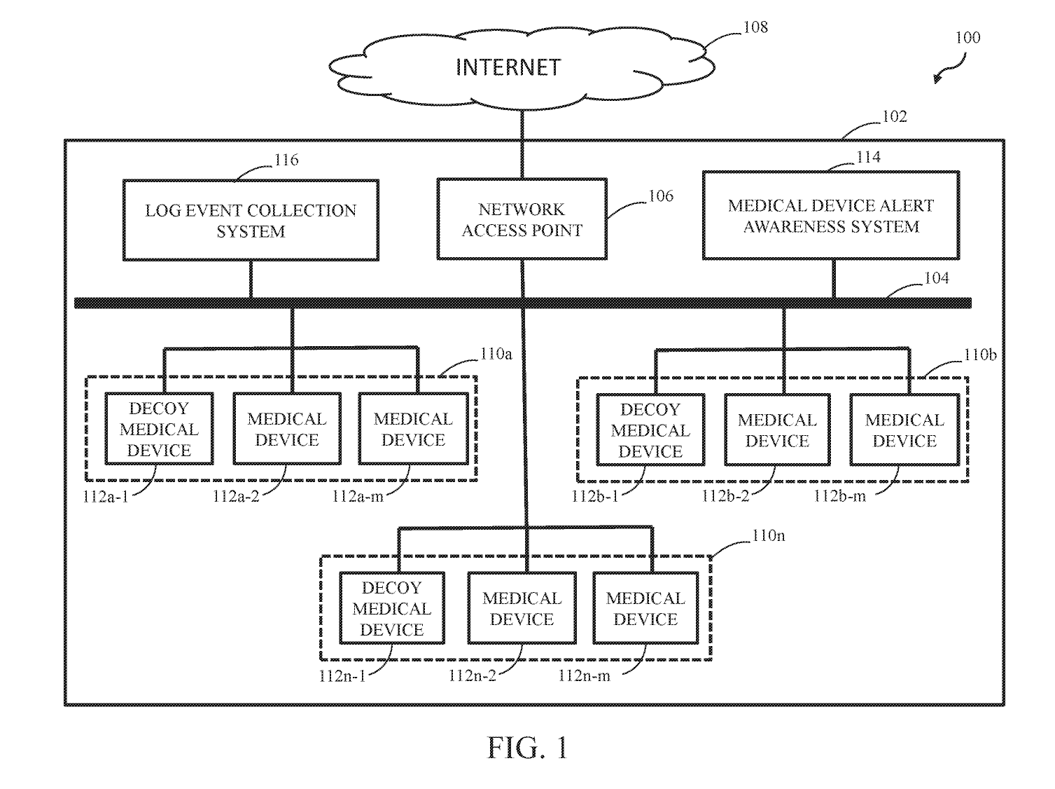

FIG. 1 illustrates an exemplary network architecture 100 in accordance with the systems and methods described herein. The exemplary network architecture 100 can include a medical facility computer network (MFCN) 102. While a medical facility network is used for the sake of explanation, the network architecture 100 can be used in other organizations as well, including hospitals. The network architecture 100 can include wireless and/or wired wireless networks including but not limited to cellular, WiFi, Bluetooth, Ethernet, public switched telephone network, and the like.

In some examples, the MFCN 102 can include a backbone 104 that can be coupled to a network access point 106. The network access point 106 can separate an external environment, represented by an Internet 108, from the MFCN 102 internal environment. In an example, the network access point 106 can correspond to one or more network routers. The network access point 106 can be configured to control and/or permit communications between the Internet 108, and devices and/or systems on the medical facilities backbone network 104. In some examples, the network access point 106 can include firewall, antivirus, and/or intrusion detection capabilities. Examples of antivirus technology providers can include, but not limited to, Palo Alto Networks, Inc.®, Cisco Systems Inc.®, Juniper Networks Inc.®, Fortinet®, McAfee®, Symantec Corporation®, or the like. Although the MFCN 102 in FIG. 1 is shown as only having a single network access point 106, the MFCN 102 can include a plurality of network access points, each of which that can be configured to control access to a given portion of the MFCN 102, including other computer networks and subnetworks (or subnets).

The MFCN 102 can further include a plurality of subnets 110a-n, wherein “n” is an integer greater than or equal to one. In some examples, each subnet can correspond to a respective virtual local area network (VLAN). Each subnet 110a-n can include a plurality of medical devices 112a-m, wherein “m” is an integer greater than or equal to one. In some examples, each subnet 110a-n can include a plurality of similar medical devices 112a-m or different medical devices 112a-m. In the example, wherein the medical devices are similar medical devices 112a-m, such devices can be from a given medical device manufacturer. A medical device can correspond to any device that can be used in diagnosis, treatment (e.g., therapeutic), physiological monitoring, and/or medical analytics. Medical devices can include, but not limited to, diagnostics imaging systems (e.g., ultrasounds, magnetic resonance imaging (MRI), positron emission tomography (PET), computed tomography (CT) scan, X-ray machines, etc.), treatment equipment (e.g., infusion pumps, medical lasers, surgical machinery, etc.) life support machines (e.g., ventilators, anesthetic, dialysis machines, etc.), condition monitoring devices (e.g., pulse oximeters, sphygmomanometer, electrocardiography (ECG or EKG) monitors, electroencephalography (EEG), etc.), drug dispensers, etc. Each subnet 110a-n can be assigned a unique internet protocol (IP) network address. Each medical device 112a-m on each subnet 110a-c can be assigned a respective sub address IP. Although FIG. 1 illustrates three sub-nets 110a-c, in some examples, only a single sub-net can exist on the MFCN 102.

A given medical device on each subnet 110a-n can be designated as a decoy medical device 112a-1, 112b-1, and 112n-1. A decoy medical device can correspond to a medical device that can service (or function) as a decoy (or honeypot) for a malicious actor instituting a cyberattack. Event log data associated with each decoy medical device 112a-1, 112b-1, and 112n-1 can be evaluated to determine if a respective decoy medical device is subject to cyberattack. Each medical device, including decoy medical device 112a-1, 112b-1, and 112n-1, can be configured to generate and send log event data. In some examples, each decoy medical device 112a-1, 112b-1, and 112n-1 on each subnet 110a-n can include an operating system. The operating system can include an open source operating system and a closed (or a commercial) operating system. The open source operating system can include, but not limited to, TinyOS, RIOT, Contiki, Mantis OS, Nano RK, LiteOS, FreeRTOS, Apache Mynewt, Zephyr OS, Ubuntu Core 16 (Snappy), ARM mbed, Android Things, Yocto, Raspbian, and the like. The closed (or the commercial) operating system can include, but not limited to, Windows 10 IoT, WindRiver VxWorks, Micrium pC/OS, Micro Digital SMX RTOS, MicroEJ OS, Express Logic ThreadX, TI RTOS, Freescale MQX, Mentor Graphics Nucleus RTOS, Green Hills Integrity, Particle, and the like.

Each decoy medical device 112a-1, 112b-1, and 112n-1 can be configured to emulate a real medical device. A real medical device is a medical device that can be interacting with a human, such as a patient at the hospital, or performing its intended functions as non-decoy medical device. Thus, from a malicious actor's point of view, the decoy medical device appears to as if its interacting with a human (or performing its intended functions), but when in reality the decoy medical device is not. Each decoy medical device 112a-1, 112b-1, and 112n-1 can be assigned an unused static or dynamic IP addressed as a decoy address. In some examples, each decoy medical device 112a-1, 112b-1, and 112n-1 can be configured to provide (or transmit) event log data to a collection system (e.g., log event collection system 116) on the HCN 102. For example, each decoy medical device 112a-1, 112b-1, and 112n-1 can be accessed and a syslog can be configured with an IP of the collection system and further configured to transmit the event log data to the collection system. In other examples, each decoy medical device 112a-1, 112b-1, and 112n-1 can be configured with a task automation and configuration management framework (e.g., PowerShell). An event view can be selected and defined, and paths can be defined for the event log data. In even further examples, each decoy medical device 112a-1, 112b-1, and 112n-1 can be configured with a security agent. The security agent can be configured to generate and transmit the event log data to the collection system. The collection system can be configured to receive the event log data and be configured to whitelist for events.

By using a decoy medical device on each subnet, malware on a medical device subnet can be detected prior to the malware completely compromising the MFCN 102, and resulting in a loss of human life, or human, reputational and/or financial harm to the medical facility. For example, an infected decoy medical device can be representative of that the decoy medical device is infected with malware, or that at least one other medical device on a similar subnet as the decoy medical device is also infected with the malware as the decoy medical device. Cyber-attacks can include, but not limited to, a malware attack, brute-force attack, denial of service (DOS) attacks, and other attacks (e.g., unpatched software attack). Malware can be referred to herein as software that can be used to disrupt computer operations, gather sensitive information, private information, or gain access to private systems on the organization's network. Malware can appear in a form of a code, scripts, active content, and other software. Malware can include computer viruses, Trojan horses, rootkits, key loggers, dialers, spyware, adware, and other malicious programs.

In an example, a cyber-attack, such as a malware attack, can be initiated on a medical device on a given subnet of the MFCN 102. In some examples, the medical device can correspond to at least one of the decoy medical devices 112a-1, 112b-1, and 112n-1. In other examples, the medical device can correspond to at least one other medical device a similar subnet as at least one of the decoy medical devices 112a-1, 112b-1, and 112n-1. In some instances, current security measures employed by medical facility administrators for the MFCN 102 are unable to prevent and/or detect the cyber-attack. For example, the medical facilities firewalls may be vulnerable to the particular cyber-attack, and/or the medical facilities antivirus software and/or intrusion detection system is unable to recognize the particular cyber-attack, or how to counter the particular cyber-attack. Thus, the malware can make its way onto a given medical device. The malware can spread among the medical devices from the given medical device on the given subnet of the MFCN 102. The spreading of the malware can result in at least one of the decoy medical device 112a-1, 112b-1, and 112n-1 being infected. For example, if the malware is a self-replication worm or virus, such malicious software can duplicate itself and spread to other medical devices on the subnet. As described herein, the event log data for at least one of the decoy medical devices 112a-1, 112b-1, and 112n-1 can be evaluated to determine whether a given decoy medical device has been infected. An infected decoy medical device can be an indicator of infection for at least one other medical device on a similar subnet as the infected decoy medical device. Accordingly, as described herein, a cyberattack on at least one medical device on a given subnet can be identified based on event log data associated with at least one of the decoy medical devices 112a-1, 112b-1, and 112n-1 on the given subnet.

Each decoy medical device 112a-1, 112b-1, and 112n-1 can be configured to generate event log data that can include information characterizing one or more events associated with the malware attack. The one or more events can include, but not limited to, device power events, telemetry events, alarm events, maintenance events, network events, drug delivery events, therapy events, application events, installer package events, service events, signature events, account monitoring and control events (e.g., creating of new accounts, failed user-login account attempts, account lock-out events, initializing, stopping or pausing of audit logs, and creation and deletion of system level-objects), audit events (e.g., even log clears (e.g., event type ID 104), and kernel driver signing), network port events, protocol events, and/or the like. Windows, Linux and Unix operating system event logs can be used to identify the initial steps of a system compromise: (1) initial compromise, (2) establish connectivity (3) privilege escalation (4) recognizance, (5) lateral movement, and (6) maintaining system access.

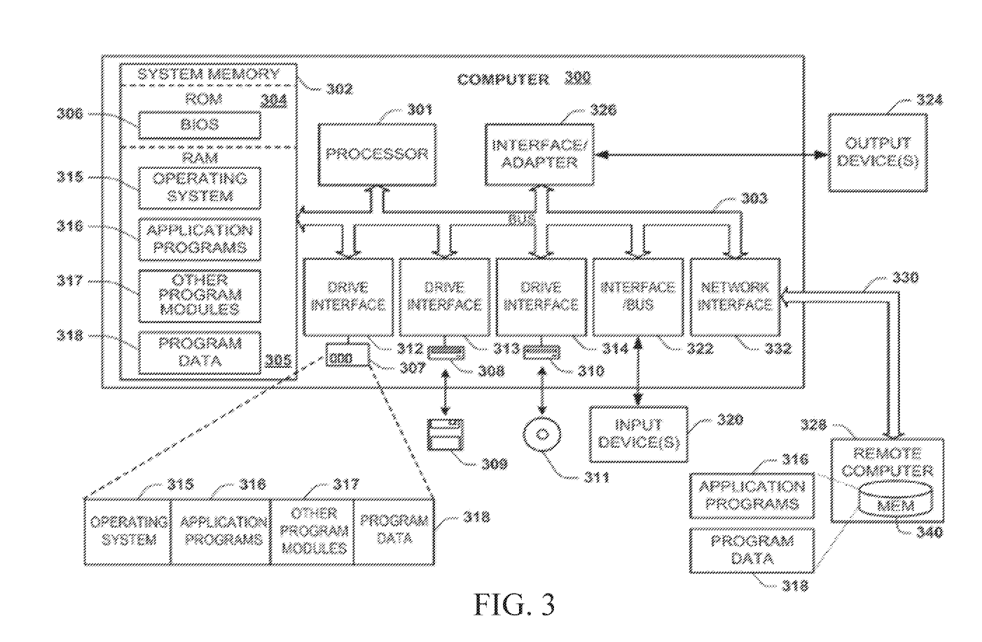

The MFCN 102 can further include a medical device alert awareness system 114. The medical device alert awareness system 114 can be configured to run on a computer, such as illustrated in FIG. 3. In an example, the medical device alert awareness system 114 can be configured to communicate with a log event collection system 116. Although the log event collection system 116 and the medical device alert awareness system 114 are shown in FIG. 1 as separate elements, in some examples, these elements can be combined as a single element, and implemented on a computer (e.g., the computer 300, as shown in FIG. 3).

The log event collection system 116 can be configured to receive the event log data associated with the medical devices on the MFCN 102. In some examples, the log event collection system 116 can be configured to query each decoy medical device 112a-1, 112b-1, 112n-1 for the event log event data. In other examples, the log event collection system 116 can be configured to monitor each decoy medical device 112a-1, 112b-1, 112n-1 for the log event data. In these examples, each decoy medical device 112a-1, 112b-1, 112n-1 can be configured to transmit (or provide) the event log data to the log event collection system 116.

In an example, the log event collection system 116 can correspond to a Security Information and Event Management (SIEM) system, or a syslog server. The log event collection system 116 can be configured to collect the event log data for each decoy medical device 112a-1, 112b-1, and 112n-1 on each subnet. In an example, the medical device alert awareness system 114 can be configured to query the log event collection system 116 to retrieve collected event log data for each decoy medical 112a-1, 112b-1, and 112n-1 on each subnet. The log event collection system 116 can be configured provide the collected event log data to the medical device alert awareness system 114. In some examples, the MFCN 102 can include a syslog server (not shown in FIG. 1).

In examples where the log event collection system 116 is a SIEM system, the SIEM system can be configured to create a watch-list and a whitelist. The watch-list and white list can include one or more events of interest associated with each decoy medical device 112a-1, 112b-1, and 112n-1. The whitelist of events are events that can represent a true indicator of compromise on a decoy medical device. The SIEM system can be configured to generate a defined watch-list and and/or condition logic to proactively monitor each medical device. For decoy medical devices that include windows operating system, the SIEM system can be configured to pull the event log data from each decoy medical device. For decoy medical devices that include Linux, Unix, Android operating systems, the SIEM system can be configured to receive the event log data from each decoy medical device. Additionally, or alternatively, the SIEM system can be configured to one of define a watch-list, context of watch list criteria (e.g., destination IP address), alarms for each decoy medical device, alarms based off watch-list(s), alarm criteria, normalization rule criteria, malware to exploit, an “AND” statement logic for normalization rule exploit against medical devices, Botnet command and control, notifications (e.g., e-mail notifications when alarm activity is triggered, including notification information), report generating (e.g., for the alarm), and a combination thereof, or the like.

In an example, the medical device alert awareness system 114 can be configured to evaluate the event log data associated with each decoy medical device 112a-1, 112b-1, and 112n-1. The medical device alert awareness system 114 can be configured to generate indicator of compromise (IOC) data based on the evaluation of the event log data for each decoy medical device 112a-1, 112b-1, and 112n-1. For example, the medical device alert awareness system 114 can be configured to evaluate the one or more events of the received log data associated with each decoy medical device 112a-1, 112b-1, and 112n-1 relative to a known list of events for each decoy medical device to identify an event that has varied from a corresponding listed event. The identified event can relate to a malicious event associated with the malware and/or malware attack. In another example, the medical device alert awareness system 114 can be configured to evaluate the one or more events of the received log data associated with each decoy medical device 112a-1, 112b-1, and 112n-1 relative to a set of rules (or filters) to identify a malicious event associated with the malware attack.

In even further examples, the medical device alert awareness system 114 can be configured to evaluate the event event log data associated with each decoy medical device 112a-1, 112b-1, and 112n-1 and event event log data associated with at least one other medical device on the given subnet (e.g., a non-decoy medical device, such as medical devices 112a-2,a-m, 112b-2,b-m, and 112n-2,n-m, as shown in FIG. 1). The medical device alert awareness system 114 can be configured to generate the IOC data based on a result of the evaluation. For example, the medical device alert awareness system 114 can compare the event log data associated with each decoy medical device 112a-1, 112b-1, and 112n-1 relative to the event log data associated with the at least one other (non-decoy) medical device for an anomaly (e.g., network usage).

The IOC data can include information corresponding to a forensic artifact and/or remnant of an intrusion that can be identified on a medical device based on log event data. The IOC data can be associated with tools, tactics, techniques, and procedures utilized by malicious actors. Thus, the IOC data can be associated with specific malicious activity from malicious actors such as spam proliferators or virus proliferators. The IOC data can include, but not limited to, an IP address, a domain name, a file hash, a uniform resource locator address (URL), C2 domain, text strings (e.g., CC, SSN, etc.), a file name, a user name, an email address, a user agent, a process hash, a process name, a registry key, or path.

The medical device alert awareness system 114 can further be configured alert the medical facilities administrator regarding the malware and/or malware attack based on the IOC data. For example, the medical device alert awareness system 114 can provide information identifying the malicious actors IP address. The medical device alert awareness system 114 can further be integrated with the existing medical facilities cyber-security systems (e.g., firewalls, intrusion detection and prevention systems, antivirus programs, or the like) to automatically block a malicious domain and/or IP address associated with the malware and/or malware attack based on the IOC data. For example, the medical device alert awareness system 114 can include a security application program interface (SARI) that can be configured for the particular cyber-security system. The medical device alert awareness system 114 can be configured to utilize the SARI to control existing medical facilities cyber-security systems to block the malicious domain and/or IP address based on the IOC data.

Therefore, the medical device alert awareness system 114 can mitigate cybersecurity risks associated with existing medical devices on the MFCN 102. The medical device alert awareness system 114 can substantially mitigate the spread of malware originating on medical devices to other devices and/or systems on the medical facilities computer network, such as the MFCN 102. Thus, a cyberattack on at least one medical device on a given subnet can be determined based on event log data associated with a decoy medical device on the given subnet. Accordingly, an infected decoy medical device can be representative that at least one other medical device beside the decoy medical device on the subnet has been infected with malware. Therefore, an infected decoy medical device can be an indicator of infection for at least one other medical device on a similar subnet as the infected decoy medical device.

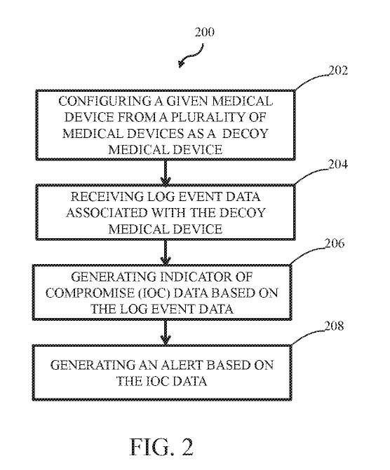

In view of the foregoing structural and functional features described above, a method that can be implemented will be better appreciated with reference to FIG. 2. While for purposes of simplicity of explanation, the method of FIG. 2 is shown and described as executing serially, it is to be understood and appreciated that such method is not limited by the illustrated order, as some aspects could, in other embodiments, occur in different orders and/or concurrently with other aspects from that shown and described herein. Moreover, not all illustrated features may be required to implement the method of FIG. 2. The method or portions thereof can be implemented as instructions stored in one or more non-transitory storage media as well as be executed by a processing resource (e.g., one or more processor cores) of a computer system, for example, as shown in FIG. 3.

FIG. 2 depicts an example of a flow diagram illustrating an example of a computer-implemented method for detecting a cyberattack on a plurality of medical devices on a medical facility computer network (e.g., the MFCN 102, as illustrated in FIG. 1). In some examples, the medical facility computer network is a hospital computer network. For example, the method 200 can be implemented by a medical device alert awareness system (e.g., the medical device alert awareness system 114, as illustrated in FIG. 1). In other examples, only a portion of the method 200 is implemented by the medical device alert awareness system. The method begins at 202, by configuring a given medical device of a plurality of medical devices on a subnet of a medical facility computer network as a decoy medical device. At 204, receiving event log data associated with the decoy medical device. The event log data can include information that can characterize one or more events at the decoy medical device, wherein at least one event of the one or more events is associated with a cyberattack on the decoy medical device. At 206, generating indicator of compromise (IOC) data based on the log event data. At 208, generating an alert based on the IOC data. The alert can be indicative of the cyberattack on at least one other medical device on the given subnet as the decoy medical device.

In view of the foregoing structural and functional description, those skilled in the art will appreciate that portions of the examples described herein may be embodied as a method, processing system, or computer program product. Accordingly, the examples described herein may take the form of an entirely hardware features, an entirely software features, or a combination of software and hardware, such as shown and described with respect to the computer system of FIG. 3. Furthermore, portions of the examples described herein may be a computer program product on a computer-usable storage medium having computer readable program code on the medium. Any suitable computer-readable medium can be utilized including, but not limited to, static and dynamic storage devices, hard disks, optical storage devices, and magnetic storage devices.

Moreover, certain examples described herein have also been referred herein with regards to block illustrations of methods, systems, and computer program products. It will be understood that blocks of the illustrations, and combinations of blocks in the illustrations, can be implemented by computer-executable instructions. These computer-executable instructions can be provided to one or more processors of a computer, or other programmable data processing apparatus (or a combination of devices and circuits) to produce a machine, such that the instructions, which execute via the one or more processors, implement the functions specified in the block or blocks.

These computer-executable instructions can also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 3 illustrates one example of a computer system 300 that can be employed to execute one or more examples described herein. Computer system 300 can be implemented on one or more general purpose networked computer systems, embedded computer systems, routers, switches, server devices, client devices, various intermediate devices/nodes or standalone computer systems. Additionally, the computer system 300 can be implemented on various mobile clients such as, for example, a personal digital assistant (PDA), laptop computer, pager, etc., provided it includes sufficient processing capabilities.

The computer system 300 can include processing unit 301, system memory 302, and system bus 303 that can couple various system components, including the system memory 302, to processing unit 301. Dual microprocessors and other multi-processor architectures also can be used as processing unit 301. System bus 303 may be any of several types of bus structure including a memory bus or memory controller, a peripheral bus, and a local bus using any of a variety of bus architectures. System memory 302 can include read only memory (ROM) 304 and random-access memory (RAM) 305. A basic input/output system (BIOS) 306 can reside in ROM 304 containing the basic routines that help to transfer information among elements within computer system 300.

The computer system 300 can further include a hard disk drive 307, magnetic disk drive 308, e.g., to read from or write to removable disk 309, and an optical disk drive 310, e.g., for reading CD-ROM disk 311 or to read from or write to other optical media. Hard disk drive 307, magnetic disk drive 308, and optical disk drive 310 can be connected to system bus 303 by a hard disk drive interface 312, a magnetic disk drive interface 313, and an optical drive interface 314, respectively. The drives and their associated computer-readable media provide nonvolatile storage of data, data structures, and computer-executable instructions for computer system 300. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of the disclosure described herein.

A number of program modules can be stored in drives and RAM 305, including operating system 315, one or more application programs 316, other program modules 317, and program data 318. A user can enter commands and information into computer system 300 through one or more input devices 320, such as a pointing device (e.g., a mouse, touch screen), keyboard, microphone, joystick, game pad, scanner, and the like. These and other input devices 320 are often connected to processing unit 301 through a corresponding port interface 322 that is coupled to the system bus, but may be connected by other interfaces, such as a parallel port, serial port, or universal serial bus (USB). One or more output devices 324 (e.g., display, a monitor, printer, projector, or other type of displaying device) can also be connected to system bus 303 via interface 326, such as a video adapter.

Computer system 300 may operate in a networked environment using logical connections to one or more remote computers, such as remote computer 328. Remote computer 328 may be a workstation, computer system, router, peer device, or other common network node, and typically includes many or all the elements described relative to computer system 300. The logical connections, schematically indicated at 330, can include a local area network (LAN) and a wide area network (WAN). When used in a LAN networking environment, computer system 300 can be connected to the local network through a network interface or adapter 332. When used in a WAN networking environment, computer system 300 can include a modem, or can be connected to a communications server on the LAN. The modem, which may be internal or external, can be connected to system bus 303 via an appropriate port interface. In a networked environment, application programs 316 or program data 318 depicted relative to computer system 300, or portions thereof, may be stored in a remote memory storage device 340.

What have been described above are examples. It is, of course, not possible to describe every conceivable combination of components or methods, but one of ordinary skill in the art will recognize that many further combinations and permutations are possible. Accordingly, the disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A computer-implemented method, comprising:
configuring a given medical device of a plurality of medical devices on a subnet of a medical facility computer network as a decoy medical device;
receiving event log data associated with the decoy medical device, wherein the event log data includes information characterizing one or more events at the decoy medical device, wherein at least one event of the one or more events is associated with a cyberattack on the decoy medical device;
generating indicator of compromise (IOC) data based on the log event data; and
generating an alert based on the IOC data, wherein the alert is indicative of the cyberattack on at least one other medical device on the given subnet as the decoy medical device.

2. The computer-implemented method of claim 1, further comprising evaluating the event log data associated with the decoy medical device to generate the IOC data.

3. The computer-implemented method of claim 2, wherein the evaluating comprises:
comparing the one or more events of the event log data relative to a known list of events for the decoy medical device; and
identifying a given event from the one or more events based on a result of the comparison, wherein the identified event corresponds to an event associated with the cyberattack.

4. The computer-implemented method of claim 2, wherein the evaluating comprises analyzing the one or more events of the event log data relative to a set of rules or filters to identify an event from the one or more events, wherein the identified event corresponds to an event associated with the cyberattack on the decoy medical device.

5. The computer-implemented method of claim 1, further comprising:
receiving event log data associated with the at least one other medical device of the plurality of devices on the subnet;
evaluating the event log data associated with the decoy medical device on the subnet relative to the event log data associated with the at least one other medical device on the subnet; and
generating the IOC data based on the evaluation.

6. The computer-implemented method of claim 1, wherein the IOC data includes one of an internet protocol (IP) address, a domain name, a file hash, a uniform resource locator (URL) address, C2 domain, text string, a file name, a user name, an email address, a user agent, a process hash, a process name, a registry key, a path, and a combination thereof associated with the cyberattack on the decoy medical device.

7. The computer-implemented method of claim 6, further comprising controlling a cybersecurity system on the medical facility network based on the IOC data.

8. The computer-implemented method of claim 7, wherein the cybersecurity system comprises one of a firewall, an antivirus, and an intrusion detection and/or prevention system.

9. The computer-implemented method of claim 8, wherein controlling the cybersecurity system comprises configuring the cybersecurity system to block a domain and/or IP address associated with the cyberattack on the decoy medical device.

10. The computer-implemented method of claim 1, wherein the one or more events includes one of a device power event, a telemetry event, an alarm event, a maintenance event, a network event, a drug delivery event, a therapy event, an application event, an installer package event, a service event, a signature event, an account monitoring and control event, an audit event, a network port event, a protocol event, and a combination thereof.

11. The computer-implemented method of claim 10, wherein the event log data associated with the decoy medical device is received provided by a log event collection system.

12. The computer-implemented method of claim 2, wherein the log event collection system comprises one of a Security Information and Event Management (SIEM) system, a syslog server, and a combination thereof.

13. The computer-implemented method of claim 1, wherein the plurality of medical devices are similar medical devices.

14. The computer-implemented method of claim 2, wherein each medical device of the plurality of medical devices corresponds to one of a diagnostics imaging system, treatment system, equipment system, life support system, condition monitoring system, and a drug dispensing system.

15. The computer-implemented method of claim 1, wherein the cyberattack is one of a malware attack, a brute-force attack and a denial of service (DOS) attack.

16. A system, comprising:
a decoy medical device located on a subnet of a medical facility computer network, the decoy medical device configured to transmit an event log data;
a collection system to receive the event log data associated with the decoy medical device, wherein the event log data includes information characterizing one or more events at the decoy medical device, wherein at least one event of the one or more events is associated with a cyberattack on the decoy medical device; and
a computer in communication with the collection system, the computer to evaluate the event log data associated with the decoy medical device to generate an indicator of compromise (IOC) data.

17. The system of claim 16, where the computer further generates an alert based on the IOC data, wherein the alert is indicative of the cyberattack on at least one other medical device on the given subnet as the decoy medical device.

18. The system of claim 16, wherein the evaluating comprises comparing the one or more events of the event log data relative to a known list of events for the decoy medical device, and identifying a given event from the one or more events based on a result of the comparison, wherein the identified event corresponds to an event associated with the cyberattack.

19. The system of claim 16, wherein the evaluating comprises analyzing the one or more events of the event log data relative to a set of rules or filters to identify an event from the one or more events, wherein the identified event corresponds to an event associated with the cyberattack on the decoy medical device.

20. The system of claim 16, wherein the IOC data includes one of an internet protocol (IP) address, a domain name, a file hash, a uniform resource locator (URL) address, C2 domain, text string, a file name, a user name, an email address, a user agent, a process hash, a process name, a registry key, a path, and a combination thereof associated with the cyberattack on the decoy medical device.
